(19) United States
(12) Patent Application Publication
(10) Pub. No.: US 2008/0218956 A1
(43) Pub. Date: Sep. 11, 2008

(54) Plasma display device

(76) Inventors: Won-Kyu Bang, Suwon-si (KR); Myoung-Kon Kim, Suwon-si (KR)

Correspondence Address: ROBERT E. BUSHNELL, 1522 K STREET NW, SUITE 300, WASHINGTON, DC, 20005-1202, US

(21) Appl. No.: 12/073,810

(22) Filed: Mar. 10, 2008

(30) Foreign Application Priority Data
Mar. 9, 2007 (KR) 10-2007-0023665

(51) Int. Cl. G06F 1/16

(52) U.S. Cl. 361/681

(57) ABSTRACT

A plasma display device allowing easy insertion of a cable into a cable connector and preventing skewing during insertion of the cable, may be constructed with a plurality of signal transmission members including a plurality of electronic devices and flexible cables, with one end of each signal transmission member connected to a circuit unit installed on a chassis base, and another end connected to the plasma display panel in order to transmit a signal that is generated by the circuit unit to drive the plasma display panel; and a plurality of cable connectors mounted on the circuit unit to electrically connect the signal transmission member to the circuit unit. Each cable connector has an inserting unit into which a cable of the signal transmission member is inserted, wherein the width of an inlet of the inserting unit gradually narrows toward the inside of the cable connector.

### CLAIM OF PRIORITY

This application makes reference to, incorporates the same herein, and claims all benefits accruing under 35 U.S.C. §119 from an application for PLASMA DISPLAY DEVICE earlier filed in the Korean Intellectual Property Office on the 9^{th} of Mar. 2007 and there duly assigned Serial No. 2007-0023665.

### BACKGROUND OF THE INVENTION

1. Field of the Invention

The present invention relates to a plasma display devices generally, and, more particularly, to a plasma display panel having a flexible cable and a connector which facilitates creation of reliable electrical connection while allowing efficient assembly of each plasma display panel.

2. Description of Related Art

Plasma display devices using plasma display panels (PDPs) are flat display devices that display images by using a gas discharge, and are considered to be the next generation of large-scale, flat panel display devices due to those of their excellent display properties such as high brightness, high contrast, lack of a residual image, wide viewing angle, and thin and large-scale display structure.

Typically, a plasma display device includes a plasma display panel (PDP), a chassis base to support the PDP, a circuit unit to drive the PDP, and a case.

The plasma display device further includes a signal transmitting conductor in which electronic devices are mounted to transmit signals between the PDP and the circuit unit.

Flat film cables (FFCs) or tape carrier packages (TCPs) are typically used as the signal transmitting conductor. Since the FFCs and TCPs generally include flexible cables, the signal transmitting conductor needs to include a cable connector that connects the flexible cable to the circuit unit.

In contemporary manufacturing practice, a flexible cable is usually a flat film which is inserted into a cable connector, and the cable is electrically connected to the cable connector. The connector usually provides a slot, to receive the cable pad, and that slot is traditionally designed to be wider than the cable pad so as to improve assembly efficiency under long-standing principles of engineering design which strive for ease and rapid assembly line pace for insertion of the cable into the slot and preservation of compactedness of the overall design of the plasma display panel.

Not infrequently, when the cable is poorly inserted into a slot of a cable connector, the alignment of the array of electrically conduction cable pads which terminate the cable become skewed relative to the direction of insertion, because an inserting unit of the connector is wider than the cable. This skewing will cause misalignment between the individual cable pads and the corresponding electrical connections housed within the cable connector, and consequently, defective electrical connections. Additionally, the cable pads may not be securely seated with their corresponding electrical connector, and a jolt subsequent to manufacture may cause an open connection and thus, a defective product.

### SUMMARY OF THE INVENTION

It is therefore, an object of the present invention to provide an improved plasma display device, and process for manufacturing an improved plasma display device.

It is another object to provide a plasma display device able to assure continuously secure electrical connections between a multi-contact cable connector and each pad in an array of pads of electrical connectors that terminate one end of a cable.

These and other objects maybe attained with present invention, which provides a plasma display device having improved working efficiency by allowing easy insertion of a cable of a signal transmitting means into a cable connector and preventing poor insertion of the cable, such as skewing.

According to an aspect of the present invention, there is provided a plasma display device including: a plasma display panel which displays an image; a chassis base disposed on the rear of the plasma display panel; a circuit unit installed on the chassis base, which generates an electrical signal to drive the plasma display panel; a plurality of signal transmission members including a plurality of electronic devices and flexible cables such that one end of each signal transmission member is connected to the circuit unit and the other end of each signal transmission member is connected to the plasma display panel in order for a signal that is generated by the circuit unit to be transmitted to the plasma display panel; and a plurality of cable connectors that are mounted on the circuit unit to electrically connect the signal transmission member to the circuit unit and each include an inserting unit in which a cable of the signal transmission member is inserted, wherein the width of an inlet of the inserting unit of the cable connector gradually narrows toward the inside of the cable connector.

The narrowest width of the inlet of the inserting unit of the cable connector maybe selected to correspond to the width of the cable.

According to another aspect of the present invention, there is provided plasma display device including: a plasma display panel which displays visible, variable video images; a chassis base disposed on the rear of the plasma display panel; a circuit unit installed on the chassis base, which generates an electrical signal to drive the plasma display panel to display the images; a plurality of signal transmission members including a plurality of electronic devices and flexible cables oriented with one end of each signal transmission member being connected to the circuit unit and the other end of each signal transmission member being connected to the plasma display panel in order for a signal that is generated by the circuit unit to be transmitted to the plasma display panel; and a plurality of cable connectors that are mounted on the circuit unit to electrically connect the signal transmission member to the circuit unit. Each of the cable connectors including insertion units in which cables of the signal transmission member may be inserted, and protruding units which protrude toward the center of the width of the inserting unit and are installed at both ends of the inlet of the inserting unit of the cable connector and have a gradually narrowing gradient that forms a taper to the inlet of the inserting unit.

The inlet of the inserting unit of the cable connector may be wider than the cable.

The narrowest width between the protruding units may be set to correspond to the width of the cable.

The cable connector may further include a cover to cover the inserting unit.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partially exploded oblique view of a plasma display device constructed as an embodiment of the present invention;

FIG. 2 is an enlarged cross-sectional view of the plasma display device taken along line II-II′ of FIG. 1, according to an embodiment of the present invention;

FIG. 3 is a partially exploded oblique view of a cable and a cable connector from FIG. 1 shown as an embodiment of the present invention;

FIG. 4 is an oblique view of the cable and the cable connector shown in FIG. 3, that have been combined with each other;

FIG. 5 is an oblique view of another embodiment the protruding units from FIG. 3 according to the principles of the present invention; and

FIG. 6 is an oblique views of another embodiment the protruding units from FIG. 3 according to the principles of the present invention

### DETAILED DESCRIPTION OF THE INVENTION

The present invention will now be described more fully with reference to the accompanying drawings, in which exemplary embodiments of the invention are shown. The invention may, however, be embodied in many different forms, and should not be construed as being limited to the embodiments set forth herein; rather, these embodiments are provided so that this disclosure will be thorough and complete, and will fully convey the concept of the invention to those skilled in the art

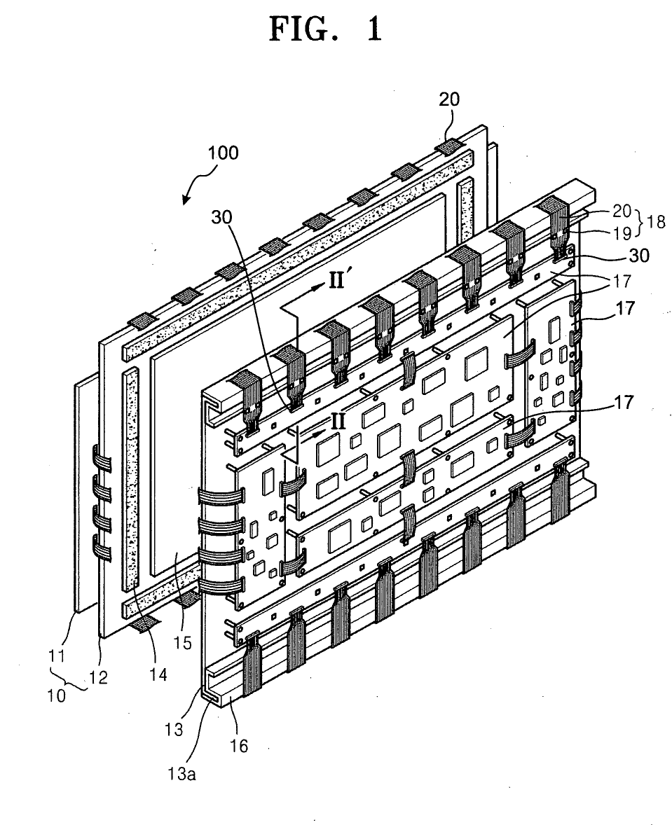

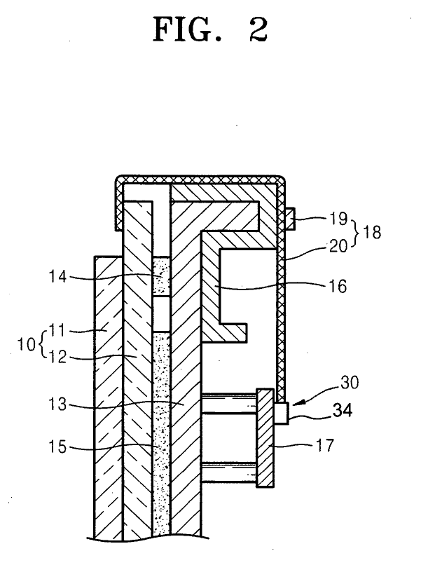

FIG. 1 is a partially exploded oblique view of a plasma display device 100 constructed as an embodiment of the principles of the present invention, and FIG. 2 is an enlarged cross-sectional view of the plasma display device taken along line II-II′ of FIG. 1, illustrating details of that embodiment of the principles of the present invention.

The plasma display device 100 illustrated in FIGS. 1 and 2 as an embodiment of the present invention, includes a plasma display panel 10, a chassis base 13 and a plurality of electrical circuit units 17 mounted upon circuit boards that are, in turn, mounted upon chassis base 13.

The plasma display panel 10 displays varying, visible video images that may be viewed by an audience facing plasma display panel, and includes a front panel 11 and a rear panel 12, wherein front panel 11 and rear panel 12 face each other and are combined together to form an operational unit. Plasma display panel 10 may be selected from various kinds of plasma display panels, for example, an alternating current (AC) PDP of a three electrode, surface discharge type. Front panel 11 and rear panel 12 include a substrate, a plurality of electrodes disposed on the substrate such that a voltage may be applied to the electrodes during operation of plasma display panel 10, and dielectric layers covering those electrodes.

At the rear of the plasma display panel 10, chassis base 13 is installed to support plasma display panel 10. Chassis base 13 is combined with plasma display panel 10 by using an adhesive material 14 such as double-sided tape or alternatively, a bonding agent. In the present embodiment, adhesive material 14 is disposed along the edge of the chassis base 13. In addition, chassis base 13 receives heat generated by plasma display panel 10 during its operation while displaying varying video images, and smoothly dissipates the heat to the ambient environment on the outside of the assembled display device. Accordingly, chassis base 13 may be formed of a material having excellent heat conduction properties, such as aluminum. In order to reduce the weight and manufacturing cost of chassis base 13, chassis base 13 may be formed of a synthetic resin. And chassis base 13 may be manufactured by casting or by press processing. Chassis base 13 may have a bend portion 13a that forms a flange which is bent perpendicularly away from plasma display panel 10 and is located along on the upper and lower parts of the chassis base 13 as a stiffener.

A heat transmitting element 15 such as a thermally conducting sheet of a material exhibiting a high value of thermal conductive, may be interposed between the plasma display panel 10 and chassis base 13. Heat transmitting element 15 partially disperses heat generated by the plasma display panel 10 while the plasma display device 100 operates to entertain viewers who are facing panel 10 an watching the visible, varying video images formed on panel 10 in response to video signals applied to display device 100 via electrical circuits 17. In addition, heat transmitting element 15 smoothly transmits heat from the plasma display panel 10 to the chassis base 13, and thus the heat can be easily dissipated to the outside. As illustrated in FIG. 2, heat transmitting element 15 may be closely adhered to the plasma display panel 10 and the chassis base 13; however, the practice of present invention is not limited thereto. Hence, one surface of the heat transmitting element 15 may contact plasma display panel 10 and another surface of heat transmitting element 15 may be spaced apart from chassis base 13, and heat transmitting element 15 may be formed of graphite or alternatively, of silicon.

A supporting member 16 may be installed along the edges and both of the adjoining sides of upper and lower flanges 13a of chassis base 13 in order to prevent chassis base 13 in order to further stiffen chassis base 13 and thereby present chassis base 13 from bending and twisting. Supporting member 16 may be formed of a relatively common structural material such as, by way of example, aluminum.

The circuit units 17 are installed on the rear side of chassis base 13. Circuit units 17 generate electrical signals which drive the plasma display panel 10 to display varying, visible video images for an audience watching display panel 10, when those electrical signals are applied to plasma display panel 10.

A plurality of signal transmission members 18 are interposed between circuit units 17 and the plasma display panel 10 to connect the circuit units 17 and the plasma display panel 10. The signal transmission members 18 serve to transmit electrical signals between the circuit units 17 and the plasma display panel 10, and may be constructed as a tape carrier package (TCP) or alternatively, as a flat film cable (FFC).

The signal transmission members 18 include a plurality of electronic devices 19 such as integrated circuits (ICs) entrained and supported by corresponding ones of signal transmission members 18, which function to turn the signal transmission between the circuit units 17 and the plasma display panel 10 between ON and OFF electrical states.

Typically, each signal transmission member 18 includes an electronic device 19 such as an IC, and a flexible cable 20 in a film form.

Flexible cable 20 is connected to a cable connector 30 which is mounted on circuit units 17 and is electrically connected to the circuit units 17.

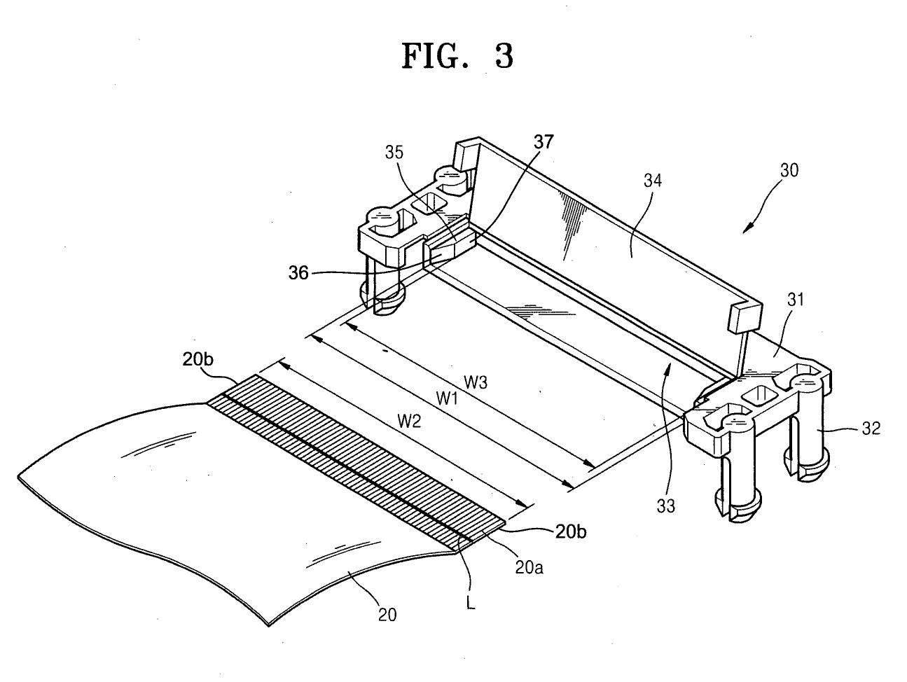

FIG. 3 is an exploded perspective view of a cable 20 aligned for insertion into a cable connector 30 of FIG. 1 according to the practice of an embodiment of the present invention.

Referring to FIG. 3, cable connector 30 includes a base 31, and a cover 34 which is rotatably installed on base 31. Cover 34 may rotate by being combined with the base 31 with a hinge (not separately shown). Base 31 includes connecting pins 32 to be mounted on the circuit units 17, and a plurality of electrically coupling pins (not separately illustrated) on its rear surface which spatially correspond to discrete, individual ones of the electrically conducting pads aligned in an array known as a pad unit 20a, which terminates one end of cable 20.

The base 31 includes an inserting unit 33 such that when linearly aligned, pad unit 20a of the cable 20 is inserted into the inlet formed by inserting unit 33. Pad unit 20a of cable 20 is inserted into inserting unit 33 to make electrical contact with individual electrically connecting devices included inside base 31.

The width W1 of the inlet of the inserting unit 33 is made wider than the width W2 of the pad unit 20a of the cable 20, to order to improve efficiency of assembling the cable 20 and the cable connector 30 when the pad unit 20a of the cable 20 is inserted into the inlet of the inserting unit 33.

The width W1 of the inlet of the inserting unit 33 is tapered and gradually narrows toward the inside of the cable connector 30. Accordingly, pad unit 20a of cable 20 can be easily and reliably inserted into the inlet of the inserting unit 33. Further, misalignment between the inlet of the inserting unit 33 and the pad unit 20a, which may be caused because the inlet of the inserting unit 33 is, at the initial entrance of the inlet, wider than the pad unit 20a of the cable in order to improve efficiency during the manufacturing assembly of the plasma display panel, can be prevented, and skewing can also be prevented. For this, the narrowest width of the inserting unit 33 may be established to correspond to the width of pad unit 20a of cable 20.

According to an embodiment of the present invention, protruding units 35 are installed at both ends of the inlet of inserting unit 33. The protruding units 35 have a gradual gradient provided by ramps 36 from the inlet toward the inside of the inserting unit 33. That is, the presence of the ramped surfaces 36 causes the thicknesses of protruding units 35 to gradually increase in a direction of insertion of pad unit 20a, as pad unit 20a travels into the inlet. Here, the narrowest width W3 between the protruding units corresponds to the width W2 of the pad unit 20a for the cable 20. Accordingly, pad unit 20a of cable 20 can be smoothly inserted into inserting unit 33.

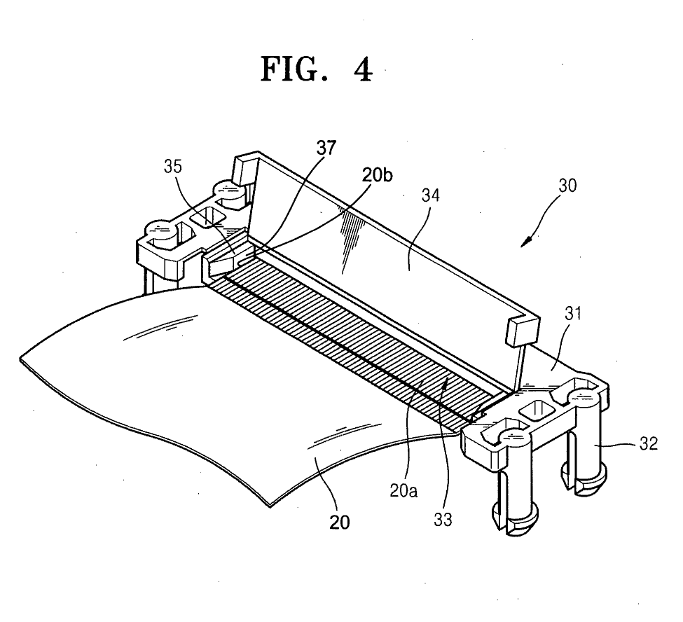

As illustrated in FIG. 4, the distance between the protruding units 35 may be designed so that side surfaces 37 of protruding units 35 support the edges 20b of the outside surface of cable 20 after cable 20 is inserted into inserting unit 33.

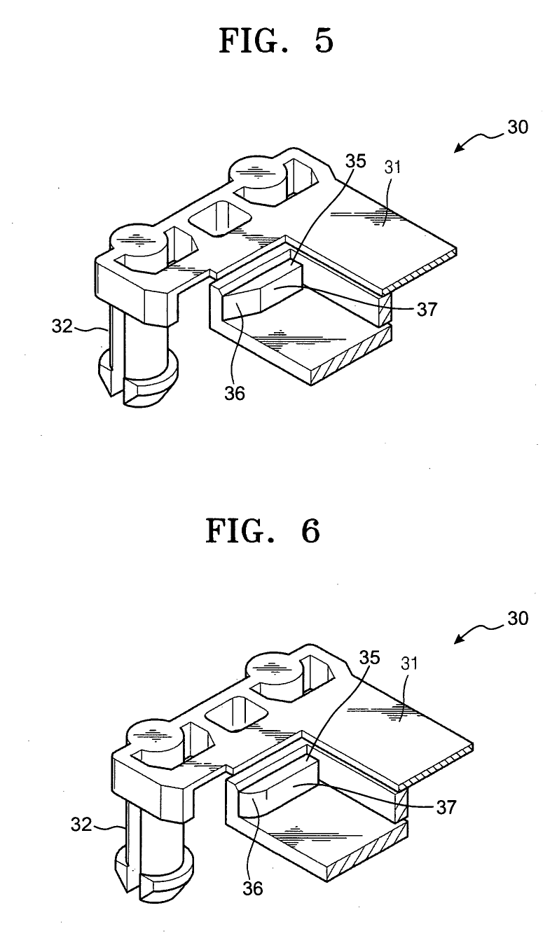

As illustrated in FIG. 5, the protruding units 35 may have a linear incline provided by ramps 36 that extends along laterally opposite sides of the inlet of inserting unit 33, but the present invention is not limited thereto. As a geometric construct, the linear incline exhibits a gradual, continuously narrowing taper that extends along the linearly inclined surface of protruding units 35; the gradual, continuously narrowing taper may be constant in slope.

As illustrated in FIG.6, the protruding units 35 may have curved inclines which also form ramps 36 that extend along the curved surface of protruding units 35, and thus extends along laterally opposite sides of the inlet of inserting unit 33. As a geometric construct, the curved surface exhibits a continuously decrease in the difference between widths W1, W3; the gradual, continuously narrowing of the difference in widths W1, W3, may be continuously decreasing in slope.

As described above, after the cable 20 is inserted into inserting unit 33, cover 34 is closed to encase the assembly of cable 20 and cable connector 30.

In a plasma display device constructed as an embodiment of the principles of the present invention, efficiency in assembling the cable of the signal transmission member and the cable connector can be improved, misalignment between them can be prevented, and thus reliability of the display device incorporating the assembled cable and cable connector can be enhanced, while preserving the internal compactedness of the plasma display device. Application of these principles to contemporary practice provide a plasma display device able to assure the formation of continuously secure electrical connections between a multi-contact cable connector and each electrically conducting pad in an array of pads of electrical connectors that terminate one end of a cable.

The details of the foregoing description of the practice of the principles of the present invention demonstrate that those embodiments, as well as other embodiments, of these principles enable a rapid and efficient high volume production of large-scale, flat panel display devices which exhibit reliable internal electrical connections that assure such excellent display properties as high brightness, high contrast, lack of a residual image, wide viewing angle, and thin and large-scale display structure.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A plasma display device, comprising:
a plasma display panel disposed to display images;
a chassis base disposed on the rear of the plasma display panel;
a circuit unit installed on the chassis base to generate an electrical signal to drive the plasma display panel to display the images;
a signal transmission member including a plurality of electronic devices and flexible cables, one end of each signal transmission member being connected to the circuit unit and another end of each signal transmission member being connected to the plasma display panel, in order for a signal generated by the circuit unit to be transmitted to the plasma display panel; and
a cable connector mounted on the circuit unit to electrically connect the signal transmission member to the circuit unit, the cable connector comprising an inserting unit providing an inlet into which the cable of the signal transmission member may be inserted, a width of the inlet of the inserting unit of cable connector gradually narrowing towards an inside of the cable connector.

2. The plasma display device of claim 1, comprised of a narrowest width of the inlet of the inserting unit of the cable connector corresponding to a width of the cable.

3. The plasma display device of claim 1, wherein the cable connector further comprises a cover to cover the inserting unit.

4. A plasma display device, comprising:
a plasma display panel which displays images;
a chassis base disposed on the rear of the plasma display panel;
a circuit unit installed on the chassis base, to generate an electrical signal to drive the plasma display panel to display the images;
a signal transmission member including a plurality of electronic devices and flexible cables, one end of each signal transmission member being connected to the circuit unit and another end of each signal transmission member being connected to the plasma display panel in order for a signal generated by the circuit unit to be transmitted to the plasma display panel; and
a cable connector mounted on the circuit unit to electrically connect the signal transmission member to the circuit unit, the cable connector comprising:
an inserting unit providing an inlet into which the cable of the signal transmission member may be inserted, and
protruding units which protrude toward a center of a width of the inserting unit, installed at both ends of the inlet of the inserting unit of the cable connector, and form gradually tapered gradients to the inlet of the inserting unit.

5. The plasma display device of claim 4, wherein the inlet of the inserting unit of the cable connector is wider than the cable.

6. The plasma display device of claim 4, wherein a narrowest width between the protruding units corresponds to the width of the cable.

7. The plasma display device of claim 4, wherein the cable connector further comprises a cover to cover the inserting unit.

8. A plasma display device, comprising:
a plasma display panel which displays images;
a circuit unit installed on the chassis base, to generate an electrical signal to drive the plasma display panel to display the images;
a chassis base joined to the plasma display device;
a signal transmission member including a plurality of electronic devices and flexible cables, one end of each signal transmission member being connected to the circuit unit and another end of each signal transmission member being connected to the plasma display panel in order for a signal generated by the circuit unit to be transmitted to the plasma display panel; and
a cable connector mounted on the circuit unit to electrically connect the signal transmission member to the circuit unit, the cable connector comprising:
an inserting unit providing an inlet into which a terminal end of the cable of the signal transmission member may be inserted, and
a plurality of spaced-apart glides disposed on opposite sides of the inlet of the inserting unit to gradually reduce a width of the inlet to conform to a corresponding cross-sectional dimension of the cable of the signal transmission member.

9. The plasma display device of claim 8, wherein a threshold of the inlet of the inserting unit of the cable connector is wider than the corresponding cross-sectional dimension of the terminal end of the cable.

10. The plasma display device of claim 8, wherein a narrowest width between the protruding units is substantially equal to the corresponding cross-sectional dimension of the terminal end of the cable.

11. The plasma display device of claim 8, wherein:
a threshold of the inlet of the inserting unit of the cable connector is wider than the corresponding cross-sectional dimension of the terminal end of the cable, and
a narrowest width between the protruding units is substantially equal to the corresponding cross-sectional dimension of the terminal end of the cable.

12. The plasma display device of claim 8, wherein the cable connector further comprises a cover encasing the terminal end of the cable inserting within the inserting unit.

13. The plasma display device of claim 8, wherein the cable connector further comprises a cover pivotally mounted upon the inserting unit to expose the inlet while the cover is in an opened orientation and, while the cover is in a closed orientation, to enclose the inlet and encase the terminal end of the cable inserting within the inserting unit.

14. The plasma display device of claim 8, wherein:
a threshold of the inlet of the inserting unit of the cable connector is wider than the corresponding cross-sectional dimension of the terminal end of the cable,
a narrowest width between the protruding units is substantially equal to the corresponding cross-sectional dimension of the terminal end of the cable, and
a cover is pivotally mounted upon the inserting unit to expose the inlet while the cover is in an opened orientation and, while in a closed orientation, to enclose the inlet and encase the terminal end of the cable inserting within the inserting unit.

15. The plasma display device of claim 8, wherein a plurality of cable connectors aligned spaced-apart in a row along a linear dimension of the circuit unit, with a threshold of the inlet of each of the inserting units of each cable connector being wider than the corresponding cross-sectional dimension of the terminal end of a corresponding cable.

16. The plasma display device of claim 8, wherein:
a plurality of cable connectors aligned spaced-apart in a row along a linear dimension of the circuit unit, with a threshold of the inlet of each of the inserting units of each cable connector being wider than the corresponding cross-sectional dimension of the terminal end of a corresponding cable,
a narrowest width between the protruding units is substantially equal to the corresponding cross-sectional dimension of the terminal end of the cable, and
a cover is pivotally mounted upon the inserting unit to expose the inlet while the cover is in an opened orientation and, while in a closed orientation, to enclose the inlet and encase the terminal end of the cable inserting within the inserting unit.
